(19) United States
(12) Patent Application Publication
(10) Pub. No.: US 2026/0066979 A1
(43) Pub. Date: Mar. 5, 2026

(54) METHOD AND APPARATUS FOR BEAM SEARCH IN COMMUNICATION SYSTEM

(71) Applicant: Electronics and Telecommunications Research Institute, Daejeon (KR)

(72) Inventors: Young-Hoon KIM, Daejeon (KR); Seon-Ae KIM, Daejeon (KR)

(21) Appl. No.: 19/290,162

(22) Filed: Aug. 4, 2025

(30) Foreign Application Priority Data
Aug. 30, 2024 (KR) 10-2024-0118076

(51) Int. Cl. H04B 7/06; H04B 17/318

(52) U.S. Cl. CPC H04B 7/06952; H04B 17/328

(57) ABSTRACT

A method of a transmitting node may comprise: exchanging configuration information with a receiving node; generating a received attention strength indication (RASI) signal; transmitting the RASI signal to a receiving node through a coarse beam; receiving a measurement message including RASI information; identifying whether the receiving node is located within a selected partitioned area based on the RASI information included in the measurement message; and in response to the receiving node being located within the selected partitioned area, adjusting a beam direction for beam alignment based on the RASI information, wherein the RASI information includes an RASI measurement value obtained by measuring a correlation with a sequence included in the RASI signal and a reception SNR measurement value.

### CROSS-REFERENCE TO RELATED APPLICATIONS

This application claims priority to Korean Patent Application No. 10-2024-0118076, filed on Aug. 30, 2024, with the Korean Intellectual Property Office (KIPO), the entire contents of which are hereby incorporated by reference.

### BACKGROUND

### 1. Technical Field

The present disclosure relates to a beam search technique in a communication system, and more particularly, to a beam search technique in a communication system, which facilitates determination of a beam direction using a received attention strength indication (RASI).

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Such a communication system may employ various beamforming and beam management techniques. The beam management techniques may be classified into methods such as beam determination, beam measurement, beam reporting, and beam sweeping. The communication system may require rapid determination of a beam direction to enable a terminal to quickly access a base station and may require techniques to support such operations.

### SUMMARY

The present disclosure for resolving the above-described problems is directed to providing a method and an apparatus for beam search in a communication system, which facilitate determination of a beam direction based on a received attention strength indication (RASI).

A beam search method according to a first exemplary embodiment of the present disclosure, performed by a transmitting node, may comprise: exchanging, with a receiving node, configuration information for beam direction search; generating a received attention strength indication (RASI) signal based on the configuration information; transmitting the RASI signal to a receiving node through a coarse beam via a selected partitioned area among partitioned areas within a beam search direction, in a transmission occasion of the RASI signal based on the configuration information; receiving, from the receiving node, a measurement message including RASI information; identifying whether the receiving node is located within the selected partitioned area based on the RASI information included in the measurement message; and in response to the receiving node being located within the selected partitioned area, adjusting a beam direction for beam alignment based on the RASI information, wherein the RASI information includes an RASI measurement value obtained by measuring a correlation with a sequence included in the RASI signal and a reception signal-to-noise ratio (SNR) measurement value.

The configuration information may include at least one of: a number of the partitioned areas within the beam search direction, information on a first partitioned area in which the RASI signal is to be transmitted, or information on criteria for partitioned area selection.

The configuration information may include Global Positioning System (GPS) location information of the transmitting node and GPS location information of the receiving node.

The identifying of whether the receiving node is located within the selected partitioned area may comprise: in response to the RASI measurement value being greater than or equal to a preset first threshold value, determining that the receiving node is located within the selected partitioned area.

The adjusting of the beam direction for beam alignment may comprise: mapping the RASI measurement value to information on previously stored relative angle(s); in response to two stored relative angles being mapped to the RASI measurement value, determining a direction of a relative angle; and adjusting the beam direction in which the RASI signal is transmitted by the relative angle of the determined direction.

The generating of the RASI signal may comprise: generating a first signal, a second signal, and a third signal for transmission to the partitioned areas within the beam search direction; and generating the RASI signal by mapping the first signal to frequency resources of a first symbol and evenly mapping the second signal and the third signal to frequency resources of a second symbol.

The first symbol and the second symbol may be consecutive symbols, the second signal may be mapped to odd-numbered frequency resources of the second symbol, and the third signal may be mapped to even-numbered frequency resources of the second symbol.

The RASI signal may be transmitted through a first beam directed toward a center of the selected partitioned area, a second beam that is offset by a predetermined angle to a right of the first beam within the selected partitioned area, and a third beam that is offset by a predetermined angle to a left of the first beam within the selected partitioned area.

The method may further comprise: transmitting information on the adjusted beam direction to the receiving node.

The method may further comprise: obtaining RASI measurement values of a plurality of partitioned areas within the beam search direction, when the receiving node is not located within the selected partitioned area; selecting a maximum RASI measurement value from the RASI measurement values; calculating an average value of remaining RASI measurement values excluding the maximum RASI measurement value among the RASI measurement values; calculating a ratio of the maximum RASI measurement value and the average value; and determining that the receiving node exists in a partitioned area having the maximum RASI measurement value, when the ratio is greater than or equal to a second threshold value.

The method may further comprise: in response to the ratio being less than the second threshold value, obtaining reception SNR measurements of the plurality of partitioned areas within the beam search direction; selecting a maximum reception SNR measurement value from the reception SNR measurements; and determining that the receiving node exists in a partitioned area having the maximum reception SNR measurement value.

A beam search method according to a second exemplary embodiment of the present disclosure, performed by a receiving node, may comprise: exchanging, with a transmitting node, configuration information for beam direction search, which is generated by the transmitting node; receiving a received attention strength indication (RASI) signal through a coarse beam in an occasion based on the configuration information; calculating an RASI measurement value obtained by measuring the received RASI signal and a reception SNR measurement value of the RASI signal; transmitting a measurement message including the RASI measurement value and the reception SNR measurement value to the transmitting node; and communicating with the transmitting node based on the measurement message.

The configuration information may include at least one of: a number of the partitioned areas within the beam search direction, information on a first partitioned area in which the RASI signal is to be transmitted, or information on criteria for partitioned area selection.

The method may further comprise: receiving, from the transmitting node, information on a beam direction for communication; and performing receive beamforming for receiving a first signal from the transmitting node and transmit beamforming for transmitting a second signal to the transmitting node, based on the information on the beam direction.

A beam search apparatus according to a third exemplary embodiment of the present disclosure, implemented as a transmitting node, may comprise at least one processor, wherein the at least one processor may cause the transmitting node to perform: exchanging, with a receiving node, configuration information for beam direction search; generating a received attention strength indication (RASI) signal based on the configuration information; transmitting the RASI signal to a receiving node through a coarse beam via a selected partitioned area among partitioned areas within a beam search direction, in a transmission occasion of the RASI signal based on the configuration information; receiving, from the receiving node, a measurement message including RASI information; identifying whether the receiving node is located within the selected partitioned area based on the RASI information included in the measurement message; and in response to the receiving node being located within the selected partitioned area, adjusting a beam direction for beam alignment based on the RASI information, wherein the RASI information includes an RASI measurement value obtained by measuring a correlation with a sequence included in the RASI signal and a reception signal-to-noise ratio (SNR) measurement value.

In the identifying of whether the receiving node is located within the selected partitioned area, the at least one processor may further cause the transmitting node to perform: in response to the RASI measurement value being greater than or equal to a preset first threshold value, determining that the receiving node is located within the selected partitioned area.

In the adjusting of the beam direction for beam alignment, the at least one processor may further cause the transmitting node to perform: mapping the RASI measurement value to information on previously stored relative angle(s); in response to two stored relative angles being mapped to the RASI measurement value, determining a direction of a relative angle; and adjusting the beam direction in which the RASI signal is transmitted by the relative angle of the determined direction.

In the generating of the RASI signal, the at least one processor may further cause the transmitting node to perform: generating a first signal, a second signal, and a third signal for transmission to the partitioned areas within the beam search direction; and generating the RASI signal by mapping the first signal to frequency resources of a first symbol and evenly mapping the second signal and the third signal to frequency resources of a second symbol.

The at least one processor may further cause the transmitting node to perform: obtaining RASI measurement values of a plurality of partitioned areas within the beam search direction, when the receiving node is not located within the selected partitioned area; selecting a maximum RASI measurement value from the RASI measurement values; calculating an average value of remaining RASI measurement values excluding the maximum RASI measurement value among the RASI measurement values; calculating a ratio of the maximum RASI measurement value and the average value; and determining that the receiving node exists in a partitioned area having the maximum RASI measurement value, when the ratio is greater than or equal to a second threshold value.

The at least one processor may further cause the transmitting node to perform: in response to the ratio being less than the second threshold value, obtaining reception SNR measurements of the plurality of partitioned areas within the beam search direction; selecting a maximum reception SNR measurement value from the reception SNR measurements; and determining that the receiving node exists in a partitioned area having the maximum reception SNR measurement value.

According to the present disclosure, a base station can transmit a received attention strength signal to a terminal and may receive a report from the terminal on a received attention strength and a signal-to-noise ratio measured based on the received attention strength signal. In addition, according to the present disclosure, the base station can quickly determine an optimal beam direction using the received attention strength and the signal-to-noise ratio received from the terminal.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3A is a conceptual diagram illustrating a relationship between an absolute polar coordinate system for beam search by a transmitting node for a receiving node and a direction of the receiving node.

FIG. 3B is a graph simulating beamforming and normalized array factors for relative angles when a transmitting node has a uniform linear array (ULA) antenna.

FIG. 3C is a graph simulating beamforming and normalized array factors for relative angles when a transmitting node has a uniform linear array (ULA) antenna.

FIG. 4 is a block diagram illustrating a first exemplary embodiment of a transmitting node.

FIG. 5 is a conceptual diagram illustrating a transmission frame for spatial random jitter beam forming transmitted by a transmitting node.

FIG. 6 is a block diagram illustrating a first exemplary embodiment of a receiving node.

FIGS. 7A and 7B are a flowchart illustrating a first exemplary embodiment of a beam search method in a communication system.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

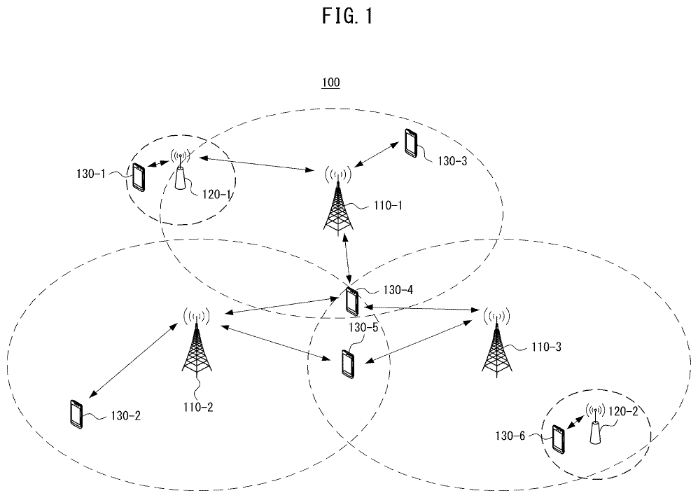

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, orthogonal frequency division multiple access (OFDMA) based communication protocol, single-carrier FDMA (SC-FDMA) based communication protocol, non-orthogonal multiple access (NOMA) based communication protocol, space division multiple access (SDMA) based communication protocol, or the like. Each of the plurality of communication nodes may have the following structure.

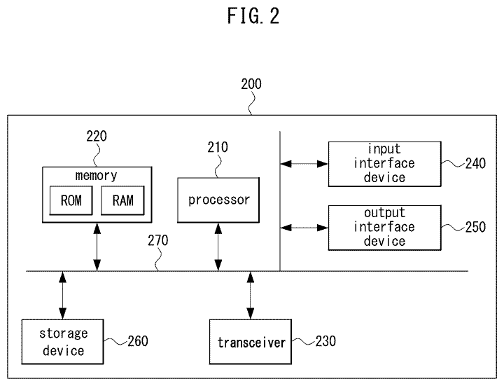

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), 5G Node B (gNB), base transceiver station (BTS), radio base station, radio transceiver, access point (AP), access node, road side unit (RSU), digital unit (DU), cloud digital unit (CDU), radio remote head (RRH), radio unit (RU), transmission point (TP), transmission and reception point (TRP), relay node, or the like. Each of the plurality of terminals 130-1, 130-2, 130-3, 130-4, 130-5, and 130-6 may be referred to as terminal, access terminal, mobile terminal, station, subscriber station, mobile station, portable subscriber station, node, device, or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New Radio (NR), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (COMP) transmission, a carrier aggregation (CA) transmission, a transmission in unlicensed band, a device-to-device (D2D) communication (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

Recently, the 5G systems and Institute of Electrical and Electronics Engineers (IEEE) 802.11.ad WiFi systems operating in 60 GHz bands may use beamforming techniques to divide a beam space (i.e. beam search section) into multiple beam directions and determine an optimal beam direction through beam sweeping. In such wireless communication systems, a technique that uses multiple antennas to form a beam in a specific direction to expand coverage and increase capacity may be successfully used as a core technology.

For this purpose, various beamforming and beam management techniques may be used.

The beam management techniques for this purpose may evolve into detailed techniques such as beam determination, beam measurement, beam reporting, and beam sweeping.

Generally, a transmission/reception point (TRP) may perform beam sweeping for all target beams within a beam space for a predetermined time duration to determine an optimal beam. Then, a user equipment (UE) may measure a received power for each beam and report results to the TRP. Accordingly, the TRP may receive information on the received power for each beam from the UE. Then, the TRP may select a beam having the maximum received beam power. This beam search method may be referred to as an exhaustive search method. However, such an exhaustive search method may have a drawback in that a search time is long.

This exhaustive search method may perform beam search using beam measurement values based on received powers. However, in the case of initial access (IA), an error in the received power measurement may be severe due to synchronization errors and channel effects. The error in the received power measurement may cause a beam determination error for a UE located near the TRP. Accordingly, the TRP and the UE may perform a reselection. As a result, the beam search time may become longer, and the beam search may become difficult.

Meanwhile, a new initial access protocol called ‘FastLink’ has recently been proposed. FastLink may also be referred to as 3-dimensional peak finding (3DPF). FastLink may be a new approach for obtaining a high antenna gain and a fast beam search time. FastLink reduces a search time by using compressive sensing (CS) technology and performing beam search based on a gradient descent search scheme using the measurement values of respective beams. However, to solve a local maximum problem, FastLink may divide a beam codebook into multiple groups. In this case, each group may be required to satisfy a condition of having a unique maximum value within the group.

As a prior art related to initial access, there is a method and apparatus for simply measuring a transmission beam of a UE at a target device to estimate a relative angle between the transmission beam and the target device. In such a method and apparatus, the UE may place a main beam direction toward the target device. In addition, the UE may transmit a preamble signal by multiplying a weight vector for forming two beams deviated at fixed angles to the left and right from a reference direction. Then, the target device may calculate a correlation using signals converted by the weight vector corresponding to the two beams deviated at fixed angles to the left and right. Accordingly, assuming that the target device is located in the reference direction, the highest correlation value may be obtained at the target device, and the target device can determine whether the UE is paying attention to the target device based on the correlation result.

Such a method may not use channel state information (CSI). In addition, such a method may result in low system overhead by using a method that simply calculates the measurement values and may enable relatively accurate beam direction estimation. Additionally, an auxiliary advantage is that a receiving device may self-determine whether the receiving device is located in the transmission beam direction, enabling various applications.

However, such a method may have limitations when applied to beam search techniques used in beam management of a wireless communication system. In other words, the UE or station may be required to know the direction of the target device in advance. However, the UE may not be able to determine in which direction from the reference direction the target device is deviated. Therefore, a separate method and device may be required for beam search necessary for beam management.

Accordingly, a technical problem that the present disclosure intends to solve is to provide a beam determination method and apparatus for determining an optimal beam direction by searching a beam direction for a UE located within a predetermined beam search space in beam management of a wireless communication system such as a 5G system. For this purpose, the present disclosure provides a method for quickly and accurately determining a beam direction of a UE by measuring a received attention strength indication (RASI) and a signal-to-noise ratio (SNR) at the UE which is relatively deviated from a specific transmission beam direction.

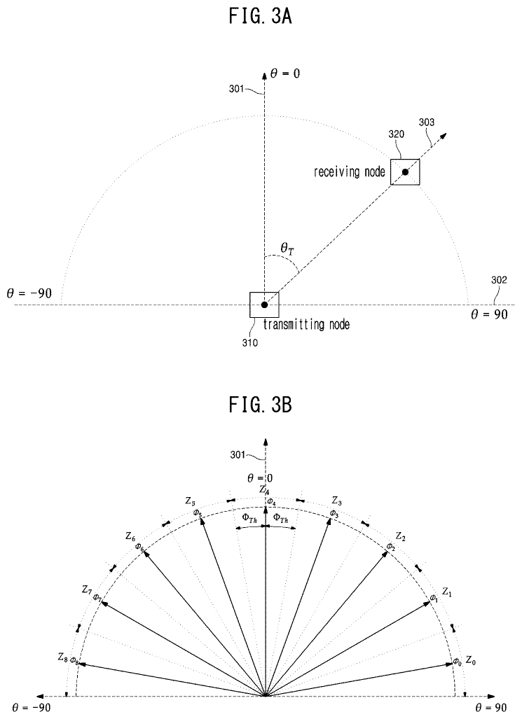

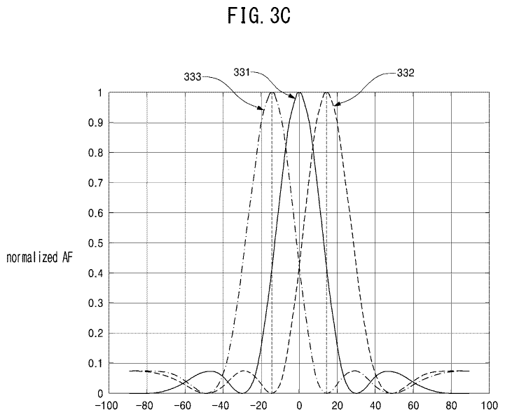

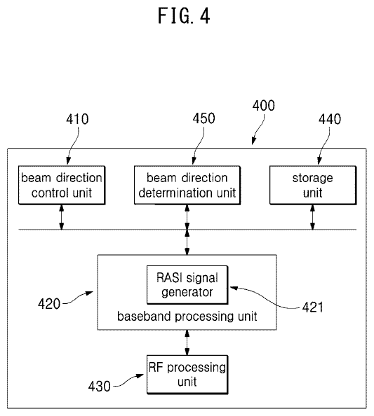

FIG. 3A is a conceptual diagram illustrating a relationship between an absolute polar coordinate system for beam search by a transmitting node for a receiving node and a direction of the receiving node.

Referring to FIG. 3A, a transmitting node 310 and a receiving node 320 are illustrated. The transmitting node 310 refers to a wireless communication device capable of transmitting a signal using beamforming technology, and the receiving node 320 may refer to a wireless communication device capable of receiving a beamformed signal. In the present disclosure as described in FIG. 3A and hereinafter, the transmitting node 310 may be understood as a communication device that performs transmission of a signal (or frame or sequence) for beam search to the receiving node 320 through beamforming. In addition, the receiving node 320 may be understood as a device capable of receiving the beamformed signal and transmitting measurement information regarding the signal to the transmitting node 310.

The transmitting node 310 and the receiving node 320 may be applied to various wireless communication systems. For example, if the transmitting node 310 and the receiving node 320 are communication devices used in the cellular wireless communication system described in FIG. 1, they may be referred to as the base station, terminal, and/or UE. In another example, if the transmitting node 310 and the receiving node 320 are used in a WiFi system, they may be referred to as a station (STA) and/or an access point (AP). In addition, they may also be applied to a satellite communication system or various IoT devices such as drones.

For example, when applied to a cellular system, the transmitting node 310 may correspond to a base station (e.g. eNB or gNB), and the receiving node 320 may correspond to a UE or IoT device. When applied to sidelink communication, the transmitting node 310 and the receiving node 320 may respectively be UEs or IoT devices. When applied to a WiFi system, the transmitting node 310 may correspond to an AP, and the receiving node 320 may correspond to various devices with a WiFi module. Examples of the various devices with a WiFi module may include computers, laptop computers, notebook computers, smartphones, smartwatches, smart glasses, etc. Furthermore, they may be applied to various fields such as Bluetooth systems and non-terrestrial network communication systems.

The transmitting node 310 and the receiving node 320 may include some or all of the components described in FIG. 2. The transmitting node 310 and the receiving node 320 may also include additional components not shown in the components of FIG. 2. The additional components may further include, for example, various types of sensors, devices for receiving satellite signals, and/or devices for user convenience. Furthermore, the transmitting node 310 may include functional components for searching for a direction of the receiving node 320 according to the present disclosure.

The functional components included in the transmitting node 310 are described in more detail with reference to the accompanying drawings. The receiving node 320 may also include a functional component for receiving a signal (or sequence or frame) transmitted from the transmitting node 310, a functional component for measuring direction-related information, and a functional component for providing direction information based on the measurement to the transmitting node 310. The functional components included in the receiving node 320 are also described in more detail with reference to the accompanying drawings. All or at least some of the functional components included in each of the transmitting node 310 and the receiving node 320 may be implemented by the processor 210 described in FIG. 2.

Referring to FIG. 3A, a case may be illustrated where the receiving node 320 is located at a point spaced a predetermined distance from the transmitting node 310, with a location of the transmitting node 310 as the origin. When the transmitting node 310 desires to transmit a signal to the receiving node 320 through beamforming, the transmitting node 310 needs to be able to identify by what angle θ7 from a predetermined reference direction 301 the receiving node 320 is located. Therefore, in the present disclosure described hereinafter, a method for the transmitting node 310 to determine either the direction in which the receiving node 320 is located or the angle θ_{T} between the reference direction 301 and the receiving node 320 is described.

First, the present disclosure may assume a case in which the transmitting node 310 and the receiving node 320 share the absolute polar coordinate system as illustrated in FIG. 3A. The absolute polar coordinate system shared between the transmitting node 310 and the receiving node 320 may be configured based on a direction configured by the system or a direction determined by mutual agreement.

As illustrated in FIG. 3A, the absolute polar coordinate system may include the reference direction 301, and the receiving node 320 may identify the reference direction 301 if the receiving node 320 receives information on the absolute polar coordinate system from the transmitting node 310. If the reference direction 301 of the absolute polar coordinate system is set to the north direction by the system or by a standard protocol, the transmitting node 310 may omit providing information on the absolute polar coordinate system to the receiving node 320 during an initial setup procedure. The present disclosure may assume a case in which the transmitting node 310 and the receiving node 320 share information on the absolute polar coordinate system by a predetermined mechanism.

The transmitting node 310 may define the reference direction 301 as 0 degrees, define a right direction from the reference direction 301 as a positive angle, and define a left direction from the reference direction 301 as a negative angle. According to the example of FIG. 3A, a case may be illustrated where a search section (or search range) is configured from 90 degrees (θ=90°) to the right and −90 degrees (θ=−90°) to the left from the reference direction.

The present disclosure describes a method in which the transmitting node 310 determines the direction θ_{T} of the receiving node 320 from the reference direction 301 in a state where the transmitting node 310 does not know the location of the receiving node 320. In addition, the present disclosure described hereinafter describes a method for determining the direction of the receiving node within a search range configured from −90° to 90° from the reference direction 301 by the transmitting node 310. Furthermore, a method and apparatus for determining a direction of a single receiving node by the transmitting node 310 are described. However, this is only for ease of understanding, and even in a case of determining directions of a plurality of receiving nodes, the same method as that of determining a direction of a single receiving node may be performed. Also, the present disclosure is described by limiting the search range to −90° to 90°. However, the present disclosure may also be applied to a search range wider than 180° or narrower than 180° regardless of whether the search range is greater or less than 180°.

FIG. 3B is a conceptual diagram illustrating a case in which a transmitting node forms beams by dividing a preconfigured search range into an arbitrary number of partitioned areas.

Referring to FIG. 3B, the transmitting node 310 may divide a search range configured from −90° to 90° into a predetermined arbitrary number of partitioned areas, for example, 9 partitioned areas Z₀, Z₁, Z₂, Z₃, Z₄, Z₅, Z₆, Z₇, and Z₈. The partitioned areas Z₀, Z₁, Z₂, Z₃, Z₄, Z₅, Z₆, Z₇, and Z₈ may all have the same angular range. In other words, since the 180° search range is divided into 9 partitioned areas, each of the partitioned areas may have an angular range of 20°. The transmitting node 310 may provide the receiving node 320 with information on the search range and the number of partitioned areas during an initial setup procedure. Accordingly, the receiving node 320 may recognize the angular range of one partitioned area based on the information on the search range and the number of partitioned areas.

The transmitting node 310 may form coarse beams in central directions of the respective partitioned areas, i.e., reference transmission beam directions ø₀, ø₁, ø₂, ø₃, ø₄, ø₅, ø₆, ø₇, and ø₈. Accordingly, each coarse beam may be formed within one of the partitioned areas Z₀, Z₁, Z₂, Z₃, Z₄, Z₅, Z₆, Z₇, and Z₈. For example, a coarse beam for the fifth reference transmission beam direction ø₄ may be formed within an angular range φ_{Th} from the reference direction 301 to a boundary of the corresponding partitioned area. More specifically, the coarse beam for the fifth reference transmission beam direction ø₄ formed in the fifth partitioned area Z₄ may be formed within the angular range from a left boundary of the partitioned area to a right boundary of the partitioned area, where the angles φ_{Th} to the left and right boundaries may have the same value. This may be because each coarse beam is formed in the center direction of the corresponding partitioned area.

Accordingly, once the search range is determined and the number of partitioned areas is determined, the angle φ_{Th} from the formed beam to the boundary may be determined as a specific value. In another example, if the search range and the angle φ_{Th} are determined, the number of partitioned areas may be determined as a specific value. The present disclosure assumes a case in which the number of partitioned areas and the angle φ_{Th} are preconfigured.

In the above description, the case may be assumed in which information on the search range and the number of partitioned areas is shared between the transmitting node 310 and the receiving node 320. In this case, instead of the search range, the transmitting node 310 and the receiving node 320 may share the number of partitioned areas and the angle φ_{Th}. Through this, the receiving node 320 may identify the search range. In addition, the number of partitioned areas and the angle φ_{Th} may be defined in form of a specific codebook. In such a case where the number of partitioned areas and the angle φ_{Th} are defined in form of a specific codebook, the transmitting node 310 and the receiving node 320 may share a codebook based on a mapping between the number of partitioned areas and the angle φ_{Th}, enabling sharing of the number of partitioned areas and the angle φ_{Th}.

In another example, depending on a type of application service, there may be cases where it is not necessary to share the number of partitioned areas and the angle φ_{Th} between the transmitting node 310 and the receiving node 320. However, for ease of understanding, the present disclosure hereinafter may assume a case in which the number of partitioned areas and the angle φ_{Th} are shared between the transmitting node 310 and the receiving node 320. Meanwhile, FIG. 3B illustrates a case in which the partitioned areas do not overlap. However, at least some of the partitioned areas may be configured to partially overlap with adjacent partitioned areas.

FIG. 3C is a graph simulating beamforming and normalized array factors for relative angles when a transmitting node has a uniform linear array (ULA) antenna.

The transmitting node 310 may have a uniform linear array (ULA) antenna. The ULA antenna may have antenna elements with the same characteristics arranged at uniform intervals. In this case, each of the antenna elements may be configured in an X-Pol form or as a single polarization antenna.

Referring to FIG. 3C, the vertical axis may represent a normalized array factor (AF), and the horizontal axis may represent the angle of the search range. The search range may be from −90° to 90°, as described with reference to FIGS. 3A and 3B. The present disclosure may use three different beams. A first beam may be a beam formed in a reference transmission beam direction using the ULA antenna to transmit a signal (or sequence) for beam search. Hereinafter, the first beam may be referred to as a first beam 331.

A second beam may be a beam formed in a direction deviated by a preconfigured angle within a boundary angle of the partitioned area from the reference transmission beam direction in the right direction, as illustrated in FIG. 3B. Hereinafter, the second beam may be referred to as a second beam 332. A third beam may be a beam formed in a direction deviated by a preconfigured angle within a boundary angle of the partitioned area from the reference transmission beam direction in the left direction, as illustrated in FIG. 3B. Hereinafter, the third beam may be referred to as a third beam 333. The deviation angle of the first beam 331 and the second beam 332 may be configured to be the same as the deviation angle between the first beam 331 and the third beam 333.

The transmitting node 310 may transmit signals to the receiving node 320 through the first beam 331, the second beam 332, and the third beam 333. In response, the receiving node 320 may receive the signals from the transmitting node 310 through the first beam 331, the second beam 332, and the third beam 333. The receiving node 320 may generate measurement beam information for the signals received through the first beam 331, the second beam 332, and the third beam 333 and provide the information to the transmitting node 310.

In an exemplary embodiment of the present disclosure, when the first beam 331, the second beam 332, and the third beam 333 are applied to an OFDM wireless communication system, each of the first beam 331, the second beam 332, and the third beam 333 may be allocated in the frequency domain. A method for generating the first beam 331, the second beam 332, and the third beam 333 by the transmitting node 310 using an array of M antennas in the OFDM wireless communication system may be as follows. Here, M may be a positive integer.

The reference beam, i.e., the first beam 331, may be generated by Equation 1, and the right-side beam of the first beam 331, i.e., the second beam 332, and the left-side beam of the first beam 331, i.e., the third beam 333, may be generated by Equation 2. Here, generating the first beam 331, the second beam 332, and the third beam 333 may mean that the respective beams are formed in the directions described in FIG. 3C.

$${X}_{k , m}^{ref} = {X}_{k} , k ∈ P , m = 1 , ⋯ , M \qquad [ Equation 1 ]$$

$${X}_{k , m}^{SRJB} = \{ \begin{matrix}{X}_{k , m}^{L} = {X}_{k} \cdot {w}_{L , m}^{*} , & k ∈ {P}_{L} , m = 1 , ⋯ , M \\ {X}_{k , m}^{R} = {X}_{k} \cdot {w}_{R , m}^{*} , & k ∈ {P}_{R} , m = 1 , ⋯ , M\end{matrix} \qquad [ Equation 2 ]$$

In Equations 1 and 2, m may denote an m-th antenna among the total M antennas, k may denote a subcarrier, ref may denote the first beam 331 as the reference beam, and P may denote locations where the reference beam is allocated in frequency resources within the OFDM symbol. Also, in Equations 1 and 2, Xₖ may denote preamble symbols that are predefined or pre-known between the transmitting node 310 and the receiving node 320. Therefore,

$${X}_{k , m}^{ref}$$

defined in Equation 1 may denote a symbol transmitted through the k-th subcarrier and the m-th antenna for forming the first beam 331. Here, M may be a positive integer. Also, P may include a positive integer number of subcarriers.

The signal transmitted by the reference beam, i.e., the first beam 331, may be a baseline received attention strength signal, and may be referred to as a baseline attention signal. Therefore,

$${X}_{k , m}^{ref}$$

defined in Equation 1 may be the baseline received attention strength signal or the baseline attention signal.

In Equation 2, L may denote the third beam 333 as the left-side beam of the first beam 331, and R may denote the second beam 332 as the right-side beam of the first beam 331. Also, in Equation 2, W_{L,m} may denote weights for the third beam 333 and may have real numbers, and W_{R,m} may denote weights for the second beam 332 and may have real numbers. For example, the weights W_{L,m} for the third beam 333 and the weights W_{R,m} for the second beam 332 may use values based on a spatial random jitter beam forming (SRJBF) scheme. In another example, the weights W_{L,m} for the third beam 333 and W_{R,m} for the second beam 332 may use weight values that steer the respective beams by a relative angle δ such that the array factor AF of each beam reaches one-half of the maximum AF when the relative angle δ between the second beam 332 and the third beam 333 is zero. Here, the value ½ used for steering by the relative angle may be an example, and other values such as ⅔, 0.7, or 0.75 may also be used. Here, M may be a positive integer.

X* may denote a complex conjugate of X. Therefore,

$${X}_{k , m}^{L}$$

in Equation 2 may denote a symbol transmitted through the k-th subcarrier and the m-th antenna for forming the third beam 333, and

$${X}_{k , m}^{R}$$

may denote a symbol transmitted through the k-th subcarrier and the m-th antenna for forming the second beam 332.

In addition,

$${X}_{k , m}^{SRJB}$$

in Equation 2 may denote a spatial random jitter beam formed (SRJBFed)-symbol (or sequence) that is transmitted through the subcarrier k from the m-th antenna. The SRJBF scheme is a technique that reduces a beam width without increasing the number of antennas and may be used in object recognition fields to spatially distinguish a counterpart node in a look direction of a user. The second beam 332 and the third beam 333 described in the present disclosure may be formed based on beam patterns that are pre-designed according to the SRJBF scheme (i.e. weight values for the respective antennas).

The signal transmitted by the second beam 332, which is the right-side beam of the first beam 331, may be a right reference received attention strength signal and may be briefly referred to as a right reference attention signal. Therefore,

$${X}_{k , m}^{R}$$

defined in Equation 2 may be the right reference received attention strength signal or the right reference attention signal. Also, the signal transmitted by the third beam 333, which is the left-side beam of the first beam 331, may be a left reference received attention strength signal and may be briefly referred to as a left reference attention signal. Therefore,

$${X}_{k , m}^{L}$$

defined in Equation 2 may be the left reference received attention strength signal or the left reference attention signal. The transmitting node 310 may generate a reference received attention strength signal composed of two lateral reference received attention strength signals as shown in Equation 2. These lateral reference received attention strength signals may be briefly referred to as lateral reference attention signals, and the reference received attention strength signal may be briefly referred to as a reference attention signal. Therefore,

$${X}_{k , m}^{SRJB}$$

defined in Equation 2 may be referred to as the reference received attention strength signal or the reference attention signal.

In this case, in applying the SRJBF scheme in the present disclosure, subcarriers in the frequency domain for the second beam 332 and the third beam 333 may be configured not to overlap. As a method for preventing overlapping use of subcarriers for each of the second beam 332 and the third beam 333, odd-numbered subcarriers may be allocated to one beam, and even-numbered subcarriers may be allocated to the other beam.

According to the above scheme, P_{L} and P_{R} defined in Equation 2 may respectively indicate the locations in the frequency resources where the left beam and the right beam are allocated in an OFDM symbol, and may not overlap with each other. In other words, an intersection of P_{L} and P_{R} may be an empty set, and a union of P_{L} and P_{R} may be equal to the frequency resources P of the first beam 331 in the OFDM symbol.

The transmitting node 310 may perform beam direction search in two stages to quickly and accurately determine a direction of the receiving node 320 located within the range of −90° to 90°, as illustrated in FIG. 3B.

In the first stage, the transmitting node 310 may identify one of the partitioned areas in which the receiving node 320 is located, among the partitioned areas divided by a predetermined number. In the second stage, the transmitting node 310 may identify (or determine) a finer direction within the partitioned area where the receiving node 320 is located.

With reference to FIGS. 3A and 3B, in the first stage, the transmitting node 310 may first identify which one of the 9 partitioned areas includes the receiving node 320. Subsequently, in the second stage, the transmitting node 310 may determine a fine direction within the partitioned area where the receiving node 320 is located. Describing the second stage again, the transmitting node 310 may determine a direction θ_{T} of the receiving node 320 from the reference direction 301 or the direction 303 in which the receiving node 320 is located, as illustrated in FIG. 3A.

For example, the receiving node 320 may be located in the fifth partitioned area Z₄. The fifth partitioned area may have the fifth reference transmission beam direction ø₄. The transmitting node 310 may detect the reference transmission beam direction ø₄ of the fifth partitioned area. Then, the transmitting node 310 may align a beam with the reference transmission beam direction ø₄. To this end, the transmitting node 310 and the receiving node 320 may share information regarding the partitioned areas within the beam search range.

Although the roles of the transmitting node 310 and the receiving node 320 are described as unidirectional, the same roles may be applied in the opposite direction. Also, the transmitting node 310 may apply the same method when searching for multiple receiving nodes simultaneously, even though only one receiving node 320 is described. Furthermore, although the search range may be limited to (−90, 90), the same method and apparatus may be applied to arbitrary search ranges. The present disclosure is described based on an OFDM wireless communication system as an exemplary embodiment, but the method and apparatus of the present disclosure may be generally and easily applied to systems other than OFDM wireless communication systems.

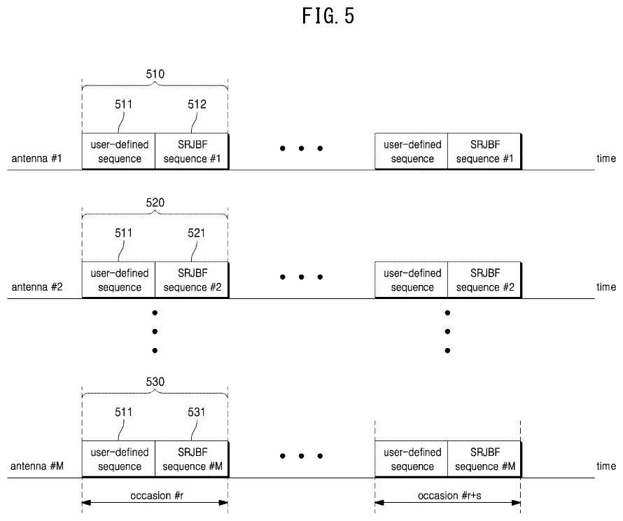

FIG. 4 is a block diagram illustrating a first exemplary embodiment of a transmitting node.

Referring to FIG. 4, a transmitting node 400 may include a beam direction control unit 410, a baseband processing unit 420, a radio frequency (RF) processing unit 430, a storage unit 440, and a beam direction determination unit 450. The baseband processing unit 420 may include a RASI signal generator 421.

The RASI signal generator 421 may generate a baseline received attention strength signal as defined in Equation 1 and transmit the signal to the RF processing unit 430. Here, the baseline received attention strength signal may be referred to as a first signal. In addition, the RASI signal generator 421 may generate a reference received attention strength signal composed of two lateral reference received attention strength signals, as defined in Equation 2. Here, the right reference received attention strength signal may be referred to as a second signal, and the left reference received attention strength signal may be referred to as a third signal.

Accordingly, the RASI signal generator 421 may generate signals to be transmitted through the beams for received attention strength measurement, as described in FIG. 3C. In other words, the RASI signal generator 421 may generate the first signal (or sequence) to be transmitted through the first beam 331, the second signal (or sequence) to be transmitted through the second beam 332, and the third signal (or sequence) to be transmitted through the third beam 333. Here, the first signal may be, for example, a preamble signal (or sequence), and the second and third signals may be signals (or sequences) generated using the first signal as described in Equation 2. The first signal, the second signal, and the third signal thus generated may be transmitted through the first beam 331, the second beam 332, and the third beam 333, respectively. A method for transmitting the first signal, the second signal, and the third signal is described in more detail with reference to the accompanying drawing.

The baseband processing unit 420 may modulate the baseline attention signal according to Equation 1 and the reference received attention strength signal according to Equation 2, and transmit them to the RF processing unit 430. In other words, the baseband processing unit 420 may encode and modulate digital data into a baseband first signal, second signal, and third signal, and then perform up-conversion to an RF band. The baseband processing unit 420 may provide the RF processing unit 430 with the up-converted wireless signal.

Then, the RF processing unit 430 may transmit the baseline received attention strength signal and the reference received attention strength signal in one of the reference transmission beam directions determined by the beam direction control unit 410. In other words, the RF processing unit 430 may power amplify the up-converted wireless signals and output each of the amplified signals through the corresponding respective antennas. Accordingly, the RF processing unit 430 may form the first beam, the second beam, and the third beam by transmitting signals through the respective antennas.

Here, the beam direction control unit 410 may determine one of the reference transmission beam directions. In this case, the beam direction control unit 410 may randomly select one transmission beam direction from among the transmission beam directions.

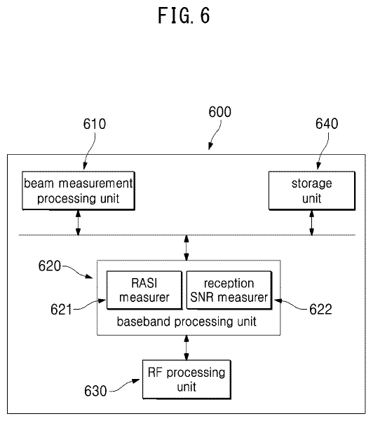

FIG. 5 is a conceptual diagram illustrating a transmission frame for spatial random jitter beam forming transmitted by a transmitting node.

Referring to FIG. 5, sequences transmitted by the transmitting node may be different for the respective antennas. FIG. 5 illustrates an example where the transmitting node has M antennas. The signal transmitted through antenna #1 may be configured as a first frame 510 including a user-defined sequence 511 and an SRJBF sequence #1 512. The signal transmitted through antenna #2 may be configured as a second frame 520 including the user-defined sequence 511 and an SRJBF sequence #2 521. The signal transmitted through antenna #M may be configured as an M-th frame 530 including the user-defined sequence 511 and an SRJBF sequence #M 531. In other words, each of the frames 510, 520, and 530 according to the present disclosure may be configured as a pair of the user-defined sequence 511 and the SRJBF sequence 512, 521, or 531 corresponding to each antenna. Hereinafter, for convenience of description, the frames 510, 520, and 530 transmitted from the respective antennas are referred to as ‘antenna-specific RASI measurement request frames’.

The user-defined sequence 511 included in each of the antenna-specific RASI measurement request frames 510, 520, and 530 may be symbols generated according to

$${X}_{k , m}^{ref}$$

generated according to Equation 1 and may be allocated to all subcarriers, i.e., the entire frequency band in the frequency domain.

The SRJBF sequences 512, 521, and 531 respectively included in the antenna-specific RASI measurement request frames 510, 520, and 530 may be symbols

$${X}_{k , m}^{SRJB}$$

generated according to Equation 2. As described in Equation 2, the symbols

$${X}_{k , m}^{SRJB}$$

may include the third signal (or sequence)

$${X}_{k , m}^{L}$$

transmitted through the left beam 333 and the second signal (or sequence)

$${X}_{k , m}^{R}$$

transmitted through the right beam 332. Here

$${X}_{k , m}^{L} and {X}_{k , m}^{R}$$

may be allocated at an equal ratio in the frequency domain. If

$${X}_{k , m}^{L} and {X}_{k , m}^{R}$$

are allocated at an equal ratio in the frequency domain,

$${X}_{k , m}^{L}$$

may be allocated to odd-numbered subcarriers and

$${X}_{k , m}^{R}$$

may be allocated to even-numbered subcarriers. In the opposite case, in other words,

$${X}_{k , m}^{R}$$

may be allocated to oud-numbered subcarriers and

$${X}_{k , m}^{L}$$

may be allocated to even-numbered subcarriers in the frequency domain.

The antenna-specific RASI measurement request frames 510, 520, and 530 described above may be generated by the RASI signal generator. The antenna-specific RASI measurement request frames 510, 520, and 530 generated by the RASI signal generator may be transmitted through the first beam, left beam, and right beam by using the baseband processing unit and the RF processing unit during a preamble transmission occasion, as described in FIG. 3C. The beams thus formed may be transmitted to the receiving node through an air channel.

In addition, the antenna-specific RASI measurement request frames 510, 520, and 530 generated as illustrated in FIG. 5 may be transmitted in an occasion #r and may be additionally transmitted in other occasions thereafter. The other occasions may be continuously transmitted from the occasion immediately following the one in which the antenna-specific RASI measurement request frames are transmitted, for a preset number of repetitions or a number agreed upon with the receiving node.

In the OFDM wireless communication system, the pairs each comprising the user-defined sequence 511 and the SRJBF sequence 512, 521, or 531, which are included in the respective antenna-specific RASI measurement request frames 510, 520, and 530, may be allocated to different OFDM symbols or allocated together in a single OFDM symbol. For example, in the case of the antenna-specific RASI measurement request frame 510 transmitted through antenna #1, the user-defined sequence 511 and the SRJBF sequence #1 512 may be allocated to the same single OFDM symbol or to different OFDM symbols. If the user-defined sequence 511 and the SRJBF sequence #1 512 are allocated to different OFDM symbols, the OFDM symbol to which the user-defined sequence 511 is allocated and the OFDM symbol to which the SRJBF sequence #1 512 is allocated may be adjacent OFDM symbols. For convenience of description, the present disclosure may assume a case in which the pair of sequences included in one antenna-specific RASI measurement request frame are respectively allocated to adjacent OFDM symbols.

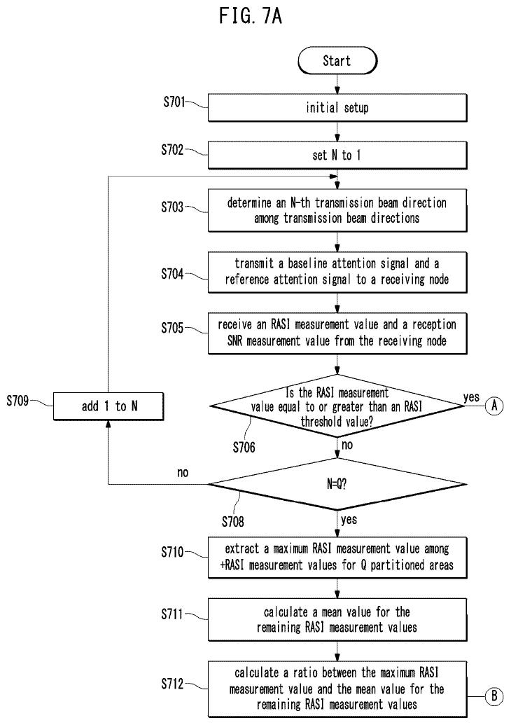

FIG. 6 is a block diagram illustrating a first exemplary embodiment of a receiving node.

Referring to FIG. 6, a receiving node 600 may include a beam measurement processing unit 610, a baseband processing unit 620, an RF processing unit 630, and a storage unit 640. Here, the baseband processing unit 620 may include a RASI measurer 621 and a reception SNR measurer 622.

The RF processing unit 630 may receive antenna-specific RASI measurement request frames from the transmitting node. The antenna-specific RASI measurement request frames may be transmitted from the transmitting node to the receiving node through the first beam formed in a reference direction, a second beam deviated from the reference direction by a predetermined angle within an angular range from the reference direction to a right-side boundary of the partitioned area, and a third beam deviated from the reference direction by a predetermined angle within an angular range from the reference direction to a left-side boundary of the partitioned area, as described with reference to FIG. 3C. The RF processing unit 630 may receive wireless signals through antennas, perform low-noise amplification, and provide the signals to the baseband processing unit 620. In other words, the RF processing unit 630 may receive the baseline received attention strength signal and the reference received attention strength signal from the transmitting node and deliver them to the baseband processor 620. The baseband processing unit 620 may convert the low-noise amplified wireless band signals into baseband signals and then convert them into digital data.

Additionally, the baseband processing unit 620 may demodulate and decode the received signals. In other words, the baseband processing unit 620 may demodulate the baseline received attention strength signal and the reference received attention strength signal into baseband signals. The demodulated digital data may be provided to the RASI measurer 621 and the reception SNR measurer 622.

The RASI measurer 621 may calculate an RASI beam measurement value ρ using the demodulated signal based on a definition of Equation 3 as shown in Equation 4. The RASI beam measurement value ρ may be understood as an RASI correlation value.

$$< \vec{X} , \vec{Y} > = {\sum }_{k ∈ P} {X}_{k}^{*} {Y}_{k} \qquad [ Equation 3 ]$$

$$ρ = \frac{< {\vec{Y}}^{ref} , {\vec{Y}}^{SRJB} >}{< {\vec{Y}}^{ref} , {\vec{Y}}^{ref} > \cdot < {\vec{Y}}^{SRJB} , {\vec{Y}}^{SRJB} >} \qquad [ Equation 4 ]$$

In Equation 3, \vec{X} is a known frequency-domain sequence in an OFDM system with a plurality of subcarriers and may indicate the user-defined sequence described in FIG. 5. Also, \vec{X} is a received signal in the frequency domain and may refer to the demodulated signal. Accordingly, \vec{Y}^{ref} may be a frequency-domain signal received through the first beam, and \vec{Y}^{SRJB} may be frequency-domain signals of the second and third beams transmitted in the SRJBF form.

The operation <\vec{X},\vec{Y}> indicates an inner product of two signals and may represent a correlation coefficient between the two signals. X* represents a complex conjugate of X.

Based on the definition of Equation 3, the RASI beam measurement value ρ may be calculated as shown in Equation 4. To calculate the RASI beam measurement value ρ, Equation 4 may use a product of an inner product between a known reference sequence and a received reference sequence and an inner product between a known SRJBF sequence and a received SRJBF sequence as a denominator, and may use an inner product between the known reference sequence and the received SRJBF sequence as a numerator.

The reception SNR measurer 622 may measure a reception SNR measurement value ρ^{SNR} from the baseline received attention strength signal and the reference received attention strength signal and store it in the storage unit 640. The beam measurement processing unit 610 may then generate a report signal including the RASI measurement value and the reception SNR measurement value and transmit the report signal to the transmitting node.

The RASI measurement value and the reception SNR measurement value may be transmitted as being included in a measurement report message. For example, when the transmitting node instructs the receiving node to report measurement of a reference signal, the RASI measurement value and the reception SNR measurement value may be transmitted in the form of a measurement report message. In this case, when the receiving node transmits the RASI measurement value and the reception SNR measurement value to the transmitting node, the receiving node may transmit them without performing beamforming. This is because a precise direction has not yet been established between the transmitting node and the receiving node, and thus information may be lost.

In addition, since the receiving node does not perform beamforming to the transmitting node, the transmitting node also may not perform beamforming when receiving the RASI measurement value and the reception SNR measurement value from the receiving node. In another example, the receiving node may transmit a measurement response message including the RASI measurement value and the reception SNR measurement value to the transmitting node through an out-band channel.

Meanwhile, referring again to FIG. 4, the transmitting node 400 may receive the measurement report message or measurement response message including the RASI measurement value and the reception SNR measurement value from the receiving node. The transmitting node 400 may receive the measurement report message or the measurement response message through an antenna in a wireless band, perform down-conversion, and obtain digital data of the measurement report message or the measurement response message through demodulation and decoding. Then, the transmitting node 400 may obtain the RASI measurement value and the reception SNR measurement value included in the measurement report message or measurement response message.

The transmitting node 400 may determine a beam direction based on the RASI measurement value and the reception SNR measurement value. In this case, the RASI measurement value and the reception SNR measurement value included in the measurement report message or measurement response message received from the receiving node may use a codebook. For example, the RASI measurement value and the reception SNR measurement value may be mapped to a preconfigured codebook, and the codebook may be pre-shared between the transmitting node 400 and the receiving node. When the codebook is pre-shared between the transmitting node 400 and the receiving node, the receiving node may transmit only information on the mapped codebook to the transmitting node, thereby achieving an effect of reducing system overhead transmitted from the receiving node to the transmitting node 400. The present disclosure does not impose any particular restrictions on how the codebook is configured. In other words, the present disclosure may utilize various forms of codebooks using the RASI measurement value and the reception SNR measurement value. Therefore, detailed descriptions related to the codebook are omitted in the present disclosure.

In the present disclosure, the transmitting node may select one of the partitioned areas using the low-density beams described in FIG. 3B based on the RASI measurement value and the reception SNR measurement value received from the receiving node. Then, a direction of the receiving node may be adjusted within the partitioned area selected based on the RASI measurement value and the reception SNR measurement value. Through this, the transmitting node may perform beam alignment for transmission to the receiving node. As described above, the transmitting node may receive the RASI measurement value and the reception SNR measurement value from the receiving node. The transmitting node may determine a beam direction from the received RASI measurement value and the reception SNR measurement value using the beam direction determination unit.

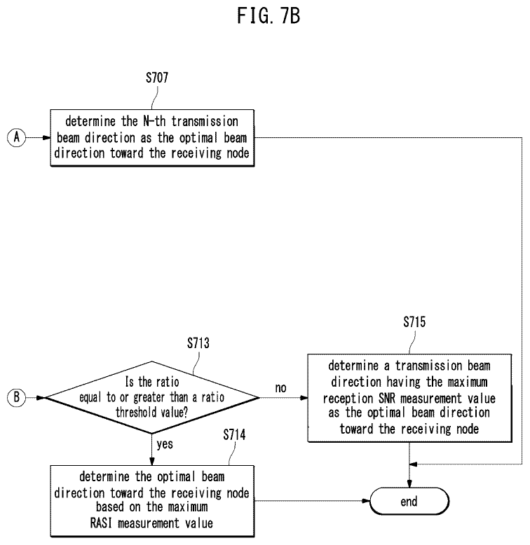

FIGS. 7A and 7B are a flowchart illustrating a first exemplary embodiment of a beam search method in a communication system.

Referring to FIGS. 7A and 7B, in a beam search method in the communication system, the transmitting node may initially set an RASI threshold value ρ^{T} and a ratio threshold value ρ^{R} to be used by the beam direction determination unit (S701). The transmitting node and the receiving node may perform an initial setup procedure as described above. The initial setup procedure may include a signaling procedure in which the transmitting node requests the receiving node to perform a beam search for transmitting a signal (or data) through beamforming, and a signaling procedure in which the receiving node accepts the beam search request from the transmitting node. Here, the threshold values may be set based on experiments or actual measurements or may be set based on various simulations.

The initial setup procedure may include a procedure in which the transmitting node provides the receiving node with information on the absolute polar coordinate system held by the transmitting node, as described in FIG. 3A. If the reference direction of the absolute polar coordinate system is set to the north pole direction by the system or standard protocol, the transmitting node may not provide information on the absolute polar coordinate system to the receiving node during the initial setup procedure. In addition, if the information on the absolute polar coordinate system includes location information of the transmitting node and the receiving node, a procedure of exchanging mutual location information may be performed by transmitting the respective location information to each other.

During the initial setup procedure, the transmitting node may provide the receiving node with information on the search range and the number of partitioned areas within the search range. Through this, the receiving node may identify the search range and the partitioned areas. In addition, the transmitting node may provide the receiving node with information a sequence (e.g. preamble sequence) to be transmitted through low-density beams in the partitioned areas.

During the initial setup procedure, the transmitting node may provide the receiving node with basic parameters for determining the low-density beam directions. For example, the parameters for beam direction determination may include information on an initial beam direction in the configured search range, that is, information on the first partitioned area for searching the receiving node. The parameters for beam direction determination may also include information on a method of selecting among the unsearched partitioned areas after searching the first partitioned area.

For example, in the case of FIG. 3B, where the first search area is the partitioned area #0 (Z₀) located farthest to the right from the reference direction, the subsequent search areas may follow a rule of proceeding sequentially toward the left. Various forms may exist for the search area selection method, and the present disclosure does not impose particular restrictions on the method of selecting the search area. Furthermore, during the initial setup procedure, information on occasions in which the RASI measurement request frame is transmitted and a periodicity of the occasions may be exchanged.

The transmitting node may set a transmission count N to 1 (S702). The base station may determine an N-th reference transmission beam direction from among the reference transmission beam directions using the beam direction control unit (S703). For example, the beam direction control unit may randomly determine the N-th reference transmission beam direction. For example, the number of reference transmission beam directions may be Q. Here, Q may be a positive integer. Alternatively, when the first search area is the one located farthest to the right from the reference direction, the beam direction control unit may select the reference transmission beam directions so that the search proceeds sequentially toward the left. Various methods of selecting search areas may exist, and the present disclosure does not impose particular restrictions on the search area selection method.

In this case, the transmitting node may select one of partitioned areas that has not been selected among the partitioned areas, that is, one of the partitioned areas in which beam alignment direction search has not been performed yet. In the case of the first partitioned area selection, the first partitioned area predetermined in the initial setup procedure may be selected. If it is not the first partitioned area selection, a subsequent partitioned area may be selected based on the method predetermined in the initial setup procedure.

Meanwhile, the transmitting node may generate an RASI signal (or sequence). The RASI signal generator may generate symbols based on the method described above in Equation 1 and Equation 2. Since this has already been described above, redundant description is omitted. The transmitting node may generate antenna-specific RASI measurement request frames based on the generated RASI signal or RASI sequence. As described in FIG. 5 above, the antenna-specific RASI measurement request frame may include an SRJBF sequence corresponding to each antenna generated on continuous symbols of a user-defined sequence. In addition, frames in which the user-defined sequence and each of the SRJBF sequences are configured may be mapped to the respective antennas. Through this, the antenna-specific RASI measurement request frames may be generated.

Then, the transmitting node may transmit the RASI signal in the determined N-th reference transmission beam direction. In other words, the transmitting node may transmit the RASI signal, composed of the baseline attention signal and the reference (i.e. lateral) attention signal, in the determined N-th reference transmission beam direction (S704).

As described above, the transmitting node may transmit the antenna-specific RASI measurement request frames through low-density beams in the corresponding partitioned area. In this case, since the low-density beams include beams in the SRJBF form as described above, the first beam as a baseline beam, the right-side beam of the first beam, and the left-side beam of the first beam may be formed and transmitted as described in FIG. 3C. In addition, the antenna-specific RASI measurement request frames may be transmitted in a predetermined occasion.

Then, the receiving node may receive the baseline attention signal and the reference attention signal from the transmitting node and may calculate an RASI measurement value and measure a reception SNR measurement value. In other words, the receiving node may receive the antenna-specific RASI measurement request frames in the predetermined occasion and information on partitioned areas transmitted from the transmitting node in the initial setup procedure. The receiving node may measure the received antenna-specific RASI measurement request frames.

As described in FIGS. 5 and 6, the antenna-specific RASI measurement request frames may be transmitted through the first beam formed in the central direction of the partitioned area to be searched, the second beam directed to the right of the first beam within the range of the partitioned area, and the third beam directed to the left of the first beam within the range of the partitioned area. The receiving node may measure these received beams. The measured information may be obtained by measuring a frequency-domain signal received through the first beam and frequency-domain signals received through the second and third beams transmitted in the SRJBF form.

The receiving node may obtain (or calculate) an RASI beam measurement value ρ based on Equation 3 and Equation 4 described above, and may obtain (or calculate) a reception SNR measurement value. Subsequently, the receiving node may transmit the RASI measurement value and the reception SNR measurement value to the transmitting node. The receiving node may transmit the RASI measurement value and the reception SNR measurement value to the transmitting node by including them in a measurement report message or a measurement response message. In this case, as described above, the measurement report message or the measurement response message may be transmitted without beamforming or may be transmitted to the transmitting node through an out-band channel. Accordingly, the transmitting node may receive the measurement report message or the measurement response message transmitted by the receiving node. Then, the transmitting node may obtain the RASI measurement value and the reception SNR measurement value from the measurement report message or the measurement response message received from the receiving node and store them in the storage (S705).

The transmitting node may determine whether the receiving node exists in the partitioned area where the antenna-specific RASI measurement request frames have been transmitted by using the RASI beam measurement value ρ. If the receiving node exists in the partitioned area where the antenna-specific RASI measurement request frames have been transmitted, the transmitting node may perform beam alignment through high-density beam direction adjustment. To this end, the beam direction determination unit of the transmitting node may determine whether the RASI measurement value received from the receiving node is equal to or greater than the RASI threshold value (S706). If the determination result shows that the RASI measurement value is equal to or greater than the RASI threshold value, the beam direction determination unit may determine the N-th reference transmission beam direction as the optimal beam direction toward the terminal (S707). On the other hand, if the determination result shows that the RASI measurement value is less than the RASI threshold value, the beam direction determination unit may determine whether N is equal to Q (S708). If the determination result shows that N is not equal to Q, the beam direction determination unit may add 1 to N (S709) and may repeat the process of determining the N-th reference transmission beam direction from among the reference transmission beam directions in the beam direction control unit.

In other words, the transmitting node may first select Z₀, the partitioned area located farthest to the right in the search range, as the first partitioned area for searching the direction of the receiving node among the partitioned areas. Then, steps S703 to S709 may be performed. If the determination result of step S709 indicates that the receiving node does not exist in the first selected partitioned area Z₀, the transmitting node may select the next partitioned area Z₁. In the above-described manner, a sequential search may be performed based on a specific direction. In another example, the search may be performed randomly, or a history-based method may be used to preferentially search expected partitioned areas. In addition, the second or third partitioned area may be selected based on the change in the RASI measurement value ρ during the subsequent partitioned area selection.

Meanwhile, if the determination result of step S708 indicates that N is equal to Q, the beam direction determination unit may extract the maximum RASI measurement value Pmax from the RASI beam measurement values for Q partitioned areas stored in the storage unit (S710). Then, the beam direction determination unit may calculate an average ρₘₑₐₙ of the remaining RASI measurement values excluding the maximum RASI measurement value among the RASI beam measurement values for the Q partitioned areas stored in the storage unit (S711). The beam direction determination unit may calculate a ratio γ of the maximum RASI measurement value to the average of the remaining RASI measurement values using Equation 5 (S712).

$$γ = \frac{{ρ}_{max}}{{ρ}_{mean}} \qquad [ Equation 5 ]$$

The beam direction determination unit may determine whether the calculated ratio is equal to or greater than the ratio threshold value (S713). If the determination result indicates that the ratio is equal to or greater than the ratio threshold value, the beam direction determination unit may determine a transmission beam direction corresponding to the maximum RASI measurement value as the optimal beam direction toward the receiving node (S714). On the other hand, if the determination result indicates that the ratio is less than the ratio threshold value, the beam direction determination unit may extract the maximum reception SNR measurement value from the reception SNR beam measurement values for the Q partitioned areas stored in the storage. Then, the beam direction determination unit may determine a transmission beam direction corresponding to the maximum reception SNR measurement value as the optimal beam direction toward the receiving node (S715). Through the method described above, the transmitting node may rapidly identify the partitioned area in which the receiving node is located. Meanwhile, the high-density beam direction adjustment procedure may use the following method.

The transmitting node may transmit antenna-specific RASI measurement request frames to the receiving node over the partitioned areas and may obtain a plurality of RASI measurement values based on a plurality of measurement report messages or measurement response messages acquired from the receiving node. The transmitting node may estimate a relative angle δ to the low-density beam direction using the RASI measurement value ρ.

The RASI measurement value ρ with respect to the relative angle δ may be stored and used as a lookup table based on measured information or may be configured using a relationship calculated by a mathematical expression. In another example, the RASI measurement value ρ with respect to the relative angle δ may be configured using a nonlinear regression analysis method or an artificial neural network. Two different relative angles δ may be mapped to a single RASI measurement value p. Therefore, in the present disclosure, when configuring the relationship between the relative angle δ and the RASI measurement value ρ, a lookup table for the relationship between a positive relative angle δ and the RASI measurement value ρ may be used, or an inverse function such as Equation 6 below may be used.

$$δ = {f}^{- 1} ( ρ ) \qquad [ Equation 6 ]$$

Then, a new beam direction, that is, a high-density beam direction, may be determined using Equation 7.

$${φ}_{New} = \{ \begin{matrix}{φ}_{Old} + {f}^{- 1} ( ρ ) , η = 0 \\ {φ}_{Old} - {f}^{- 1} ( ρ ) , η = 1\end{matrix} \qquad [ Equation 7 ]$$

In Equation 7, φ_{New} represents the new beam direction, that is, the high-density beam direction, and φ_{old} may represent the low-density beam direction for the corresponding partitioned area when the receiving node is located within the partitioned area.

If the receiving node is located to the right of the low-density beam direction φ_{old}, it may indicate that the high-density beam direction φ_{New} needs to be corrected by adding a beam direction correction value f⁻¹(ρ) to the low-density beam direction φ_{Old}. Conversely, if the receiving node is located to the left of the low-density beam direction φ_{Old}, it may indicate that the high-density beam direction φ_{New} needs to be corrected by subtracting the beam direction correction value f⁻¹(ρ) from the low-density beam direction φ_{Old}.

The high-density beam direction may be adjusted using the method described above. The high-density beam direction φ_{New} described above may be the direction θ_{T} in which the receiving node is located from the reference direction illustrated in FIG. 3A. Accordingly, using the direction θ_{T} in which the receiving node is located, the transmitting node may align a transmission beam toward the receiving node.

The transmitting node may transmit information on the transmission beam direction θ_{T} to the receiving node. Accordingly, the receiving node may receive information on the transmission beam direction θ_{T} from the transmitting node. The receiving node may perform beamforming of a reception beam using the transmission beam direction θ_{T} informed by the transmitting node. In addition, to facilitate such calculation, the transmitting node and the receiving node may each calculate Global Positioning System (GPS) location information of the transmitting node and GPS location information of the receiving node measured using GPS measurement devices and may share mutual location information, that is, the absolute coordinates of the transmitting node and the receiving node, during the initial setup procedure.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a transmitting node, comprising:
exchanging, with a receiving node, configuration information for beam direction search;
generating a received attention strength indication (RASI) signal based on the configuration information;
transmitting the RASI signal to a receiving node through a coarse beam via a selected partitioned area among partitioned areas within a beam search direction, in a transmission occasion of the RASI signal based on the configuration information;
receiving, from the receiving node, a measurement message including RASI information;
identifying whether the receiving node is located within the selected partitioned area based on the RASI information included in the measurement message; and
in response to the receiving node being located within the selected partitioned area, adjusting a beam direction for beam alignment based on the RASI information,
wherein the RASI information includes an RASI measurement value obtained by measuring a correlation with a sequence included in the RASI signal and a reception signal-to-noise ratio (SNR) measurement value.

2. The method according to claim 1, wherein the configuration information includes at least one of: a number of the partitioned areas within the beam search direction, information on a first partitioned area in which the RASI signal is to be transmitted, or information on criteria for partitioned area selection.

3. The method according to claim 1, wherein the configuration information includes Global Positioning System (GPS) location information of the transmitting node and GPS location information of the receiving node.

4. The method according to claim 1, wherein the identifying of whether the receiving node is located within the selected partitioned area comprises: in response to the RASI measurement value being greater than or equal to a preset first threshold value, determining that the receiving node is located within the selected partitioned area.

5. The method according to claim 1, wherein the adjusting of the beam direction for beam alignment comprises:
mapping the RASI measurement value to information on previously stored relative angle(s);
in response to two stored relative angles being mapped to the RASI measurement value, determining a direction of a relative angle; and
adjusting the beam direction in which the RASI signal is transmitted by the relative angle of the determined direction.

6. The method according to claim 1, wherein the generating of the RASI signal comprises:
generating a first signal, a second signal, and a third signal for transmission to the partitioned areas within the beam search direction; and
generating the RASI signal by mapping the first signal to frequency resources of a first symbol and evenly mapping the second signal and the third signal to frequency resources of a second symbol.

7. The method according to claim 6, wherein the first symbol and the second symbol are consecutive symbols, and the second signal is mapped to odd-numbered frequency resources of the second symbol, and the third signal is mapped to even-numbered frequency resources of the second symbol.

8. The method according to claim 1, wherein the RASI signal is transmitted through a first beam directed toward a center of the selected partitioned area, a second beam that is offset by a predetermined angle to a right of the first beam within the selected partitioned area, and a third beam that is offset by a predetermined angle to a left of the first beam within the selected partitioned area.

9. The method according to claim 1, further comprising: transmitting information on the adjusted beam direction to the receiving node.

10. The method according to claim 1, further comprising:
obtaining RASI measurement values of a plurality of partitioned areas within the beam search direction, when the receiving node is not located within the selected partitioned area;
selecting a maximum RASI measurement value from the RASI measurement values;
calculating an average value of remaining RASI measurement values excluding the maximum RASI measurement value among the RASI measurement values;
calculating a ratio of the maximum RASI measurement value and the average value; and
determining that the receiving node exists in a partitioned area having the maximum RASI measurement value, when the ratio is greater than or equal to a second threshold value.

11. The method according to claim 10, further comprising:
in response to the ratio being less than the second threshold value, obtaining reception SNR measurements of the plurality of partitioned areas within the beam search direction;
selecting a maximum reception SNR measurement value from the reception SNR measurements; and
determining that the receiving node exists in a partitioned area having the maximum reception SNR measurement value.

12. A method of a receiving node, comprising:
exchanging, with a transmitting node, configuration information for beam direction search, which is generated by the transmitting node;
receiving a received attention strength indication (RASI) signal through a coarse beam in an occasion based on the configuration information;
calculating an RASI measurement value obtained by measuring the received RASI signal and a reception SNR measurement value of the RASI signal;
transmitting a measurement message including the RASI measurement value and the reception SNR measurement value to the transmitting node; and
communicating with the transmitting node based on the measurement message.

13. The method according to claim 12, wherein the configuration information includes at least one of: a number of the partitioned areas within the beam search direction, information on a first partitioned area in which the RASI signal is to be transmitted, or information on criteria for partitioned area selection.

14. The method according to claim 12, further comprising:
receiving, from the transmitting node, information on a beam direction for communication; and
performing receive beamforming for receiving a first signal from the transmitting node and transmit beamforming for transmitting a second signal to the transmitting node, based on the information on the beam direction.

15. A transmitting node, comprising at least one processor, wherein the at least one processor causes the transmitting node to perform:
exchanging, with a receiving node, configuration information for beam direction search;
generating a received attention strength indication (RASI) signal based on the configuration information;
transmitting the RASI signal to a receiving node through a coarse beam via a selected partitioned area among partitioned areas within a beam search direction, in a transmission occasion of the RASI signal based on the configuration information;
receiving, from the receiving node, a measurement message including RASI information;
identifying whether the receiving node is located within the selected partitioned area based on the RASI information included in the measurement message; and
in response to the receiving node being located within the selected partitioned area, adjusting a beam direction for beam alignment based on the RASI information,
wherein the RASI information includes an RASI measurement value obtained by measuring a correlation with a sequence included in the RASI signal and a reception signal-to-noise ratio (SNR) measurement value.

16. The transmitting node according to claim 15, wherein in the identifying of whether the receiving node is located within the selected partitioned area, the at least one processor further causes the transmitting node to perform: in response to the RASI measurement value being greater than or equal to a preset first threshold value, determining that the receiving node is located within the selected partitioned area.

17. The transmitting node according to claim 15, wherein in the adjusting of the beam direction for beam alignment, the at least one processor further causes the transmitting node to perform:
mapping the RASI measurement value to information on previously stored relative angle(s);
in response to two stored relative angles being mapped to the RASI measurement value, determining a direction of a relative angle; and
adjusting the beam direction in which the RASI signal is transmitted by the relative angle of the determined direction.

18. The transmitting node according to claim 15, wherein in the generating of the RASI signal, the at least one processor further causes the transmitting node to perform:
generating a first signal, a second signal, and a third signal for transmission to the partitioned areas within the beam search direction; and
generating the RASI signal by mapping the first signal to frequency resources of a first symbol and evenly mapping the second signal and the third signal to frequency resources of a second symbol.

19. The transmitting node according to claim 15, wherein the at least one processor further causes the transmitting node to perform:
obtaining RASI measurement values of a plurality of partitioned areas within the beam search direction, when the receiving node is not located within the selected partitioned area;
selecting a maximum RASI measurement value from the RASI measurement values;
calculating an average value of remaining RASI measurement values excluding the maximum RASI measurement value among the RASI measurement values;
calculating a ratio of the maximum RASI measurement value and the average value; and
determining that the receiving node exists in a partitioned area having the maximum RASI measurement value, when the ratio is greater than or equal to a second threshold value.

20. The transmitting node according to claim 19, wherein the at least one processor further causes the transmitting node to perform:
in response to the ratio being less than the second threshold value, obtaining reception SNR measurements of the plurality of partitioned areas within the beam search direction;
selecting a maximum reception SNR measurement value from the reception SNR measurements; and
determining that the receiving node exists in a partitioned area having the maximum reception SNR measurement value.
